(19) United States
(12) Patent Application Publication
(10) Pub. No.: US 2018/0348416 A1
(43) Pub. Date: Dec. 6, 2018

(54) POLARIZER AND METHOD OF MANUFACTURING THE SAME

(71) Applicant: Samsung Display Co., Ltd., Yongin-si (KR)

(72) Inventors: Kyung Hee LEE, Suwon-si (KR); Jae Hong PARK, Seoul (KR); Ji Yun PARK, Hwaseong-si (KR); Hyung Guen YOON, Hwaseong-si (KR); Jae Bok CHANG, Incheon (KR); Kyung Seon TAK, Hwaseong-si (KR)

(21) Appl. No.: 15/710,126

(22) Filed: Sep. 20, 2017

(30) Foreign Application Priority Data
May 31, 2017 (KR) 10-2017-0067894

(51) Int. Cl. G02B 5/30; G02B 1/08

(52) U.S. Cl. CPC G02B 5/3016; G02B 1/08

(57) ABSTRACT

A polarizer comprises: an alignment layer including a photocured polymer material having a plurality of recessed portions formed at a surface to extend in a first direction; and a polarizing material layer disposed on the surface of the alignment layer having the recessed portions, the polarizing material layer including thermotropic liquid crystals and a dichroic dye.

### CROSS-REFERENCE TO RELATED APPLICATION

This application claims priority to and the benefit of Korean Patent Application No. 10-2017-0067894, filed on May 31, 2017, in the Korean Intellectual Property Office, the disclosure of which is incorporated herein by reference in its entirety.

### BACKGROUND

### 1. Field

Embodiments of the present disclosure relate to a polarizer and a method of manufacturing the same.

### 2. Description of the Related Art

A polarizer is a device that converts unpolarized incident light into polarized light by transmitting a polarization component oscillating in a direction parallel (e.g., substantially parallel) to a transmission axis and absorbing a polarization component oscillating in a direction parallel (e.g., substantially parallel) to an absorption axis. The polarizer having such a polarizing function may be applied to a display device, so that the display device can have various suitable optical functions.

For example, in a liquid crystal display, the polarizer may perform a shutter function together with a liquid crystal layer to adjust the amount of light provided from a light source, thereby realizing an image display. In another example, the polarizer may convert unpolarized light into circularly polarized light together with a phase delay layer, and this can be used to suppress or reduce the deterioration of display quality due to external light reflection.

An example of the polarizer is a polarizing plate using an iodine-polyvinyl alcohol film produced by stretching iodine-adsorbed polyvinyl alcohol.

However, polyvinyl alcohol, which is a water-soluble polymer, has poor water resistance and heat resistance. In addition, since iodine is susceptible to heat, it is sublimated when exposed to strong light or heat. Thus, polarization characteristics of the polarizer may deteriorate. Furthermore, a production process performed under a stretching/pressure process is complicated, and the iodine-polyvinyl alcohol polarizing plate has poor mechanical strength. When the iodine-polyvinyl alcohol polarizing plate shrinks due to heat or moisture, it may warp or crack. For example, since the iodine-polyvinyl alcohol polarizing plate has poor durability, its polarization characteristics may continuously or substantially continuously deteriorate. To overcome these drawbacks, there have been attempts to apply an additional protective film. However, the protective film causes an increase in the thickness of the iodine-polyvinyl alcohol polarizer.

To replace such an iodine-polyvinyl alcohol polarizing plate, there has been developed a technology of realizing polarization by aligning liquid crystal molecules to induce alignment of a dichroic dye. As methods of aligning liquid crystal molecules, a rubbing alignment method for aligning liquid crystals by forming scratches on the surface of a polymer such as polyimide, and a photoalignment method for aligning liquid crystals through light irradiation are being researched.

However, in the rubbing alignment method, defects may be generated in the polymer surface or dye during the process of physically forming scratches. In addition, in the photoalignment method, a difference in alignment power may occur due to chemical instability.

### SUMMARY

Aspects of embodiments of the present disclosure provide a polarizer which can provide stable alignment power by inducing alignment of liquid crystals in a simple way and a method of manufacturing the polarizer.

However, aspects of embodiments of the present disclosure are not restricted to the one set forth herein. The above and other aspects of embodiments of the present disclosure will become more apparent to one of ordinary skill in the art to which the present disclosure pertains by referencing the detailed description of embodiments of the present disclosure given below.

According to an aspect of embodiments of the present disclosure, there is provided a polarizer comprising: an alignment layer which comprises a photocured polymer material and has a plurality of recessed portions formed at a surface to extend in a first direction; and a polarizing material layer which is disposed on the surface of the alignment layer having the recessed portions and comprises thermotropic liquid crystals and a dichroic dye.

According to another aspect of embodiments of the present disclosure, there is provided a polarizer comprising: a first alignment layer which has a plurality of recessed portions formed at a surface to extend in a direction; a first polarizing material layer which is disposed on the surface of the first alignment layer having the recessed portions and comprises liquid crystals and a dichroic dye; an intermediate layer which is disposed on the first polarizing material layer; a second alignment layer which is disposed on the intermediate layer and has a plurality of recessed portions formed at (e.g., in) a surface to extend in the direction; and a second polarizing material layer which is disposed on the surface of the second alignment layer having the recessed portions and comprises liquid crystals and a dichroic dye.

According to another aspect of embodiments of the present disclosure, there is provided a polarizer comprising: an alignment layer which has a plurality of protruding portions formed at (e.g., in) a surface to extend in a direction; and a polarizing material layer which is disposed on the surface of the alignment layer having the protruding portions and comprises thermotropic liquid crystals and a dichroic dye.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of a polarizer according to an embodiment;

FIG. 2 is a cross-sectional view of the polarizer, taken along the line II-II′ of FIG. 1;

FIG. 3 is a plan view schematically illustrating a state in which polarizing materials are arranged on an alignment layer of the polarizer of FIG. 1;

FIGS. 4 through 6 are cross-sectional views of polarizers according to embodiments;

FIGS. 7 through 10 are cross-sectional views illustrating operations of an embodiment of a method of manufacturing the alignment layer of the polarizer illustrated in FIG. 1; and

FIGS. 11 through 13 are cross-sectional views illustrating an operation of an embodiment of a method of manufacturing a plurality of alignment layers using the alignment layer manufactured in FIG. 10.

### DETAILED DESCRIPTION

Features of the subject matter of the present disclosure and methods of accomplishing the same may be understood more readily by reference to the following detailed description of example embodiments and the accompanying drawings. The subject matter of the present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art, and the invention will only be defined by the appended claims, and equivalents thereof.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting. As used herein, the singular forms “a,” “an” and “the” are intended to include the plural forms as well, including “at least one,” unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof. “At least one” is not to be construed as limiting “a” or “an.” As used herein, the term “or” means “and/or.” As used herein, the term “and/or” includes any and all combinations of one or more of the associated listed items.

As used herein, a numerical range indicated by using “through” denotes a numerical range including first and last values as a lower limit and an upper limit, respectively.

The term “polarizer,” as used herein, may denote, but is not limited to, a coating type (e.g., kind of) thin-film polarizer which is manufactured by coating a solution containing a polarizing material and can be thinned.

As used herein, the term “dichroic” denotes that absorbance in an axial direction differs from absorbance in another axial direction.

Hereinafter, embodiments of the present disclosure will be described with reference to the accompanying drawings.

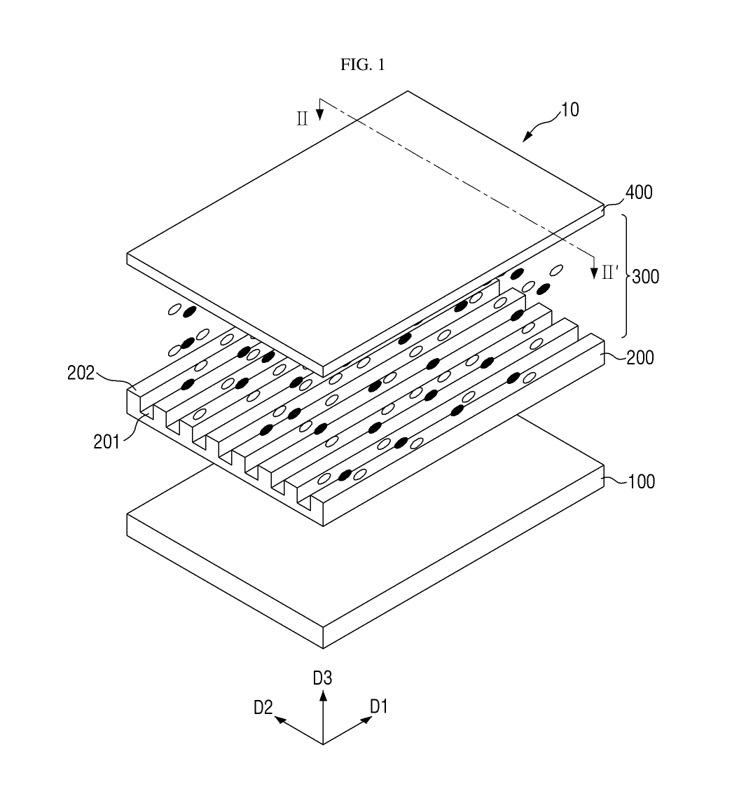

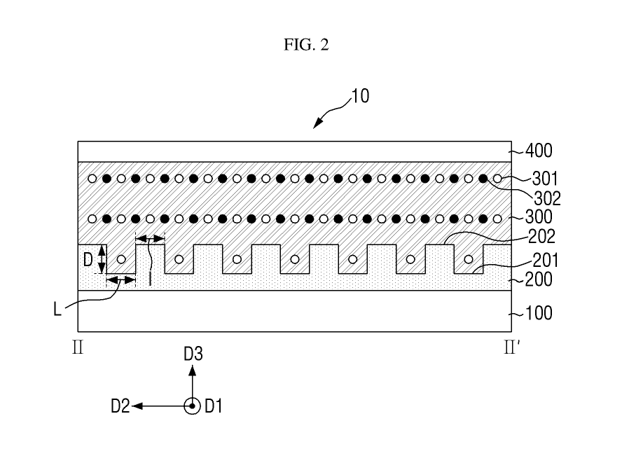

FIG. 1 is a perspective view of a polarizer 10 according to an embodiment, and FIG. 2 is a cross-sectional view of the polarizer 10, taken along the line II-II′ of FIG. 1.

Referring to FIGS. 1 and 2, the polarizer 10 includes a base substrate 100, an alignment layer 200 disposed on the base substrate 100, a polarizing material layer 300 disposed on the alignment layer 200, and a protective layer 400 disposed on the polarizing material layer 300.

The base substrate 100 may provide a space in which the alignment layer 200 can be disposed and support elements of the polarizer 10 including the alignment layer 200. The base substrate 100 may be a translucent substrate.

In an embodiment, the base substrate 100 may be a glass or plastic substrate placed to support the elements of the polarizer 10. When the polarizer 10 of the present disclosure is applied to a display device, elements such as the alignment layer 200 may be directly disposed on the display device without the base substrate 100.

For example, the polarizer 10 of the present disclosure may be provided in the form of a polarizing plate or a polarizing film including the separate base substrate 100 or may be placed directly on the display device in the form of a coating layer and integrated with a display panel.

The alignment layer 200 is disposed on the base substrate 100. A plurality of recessed portions 201 and a plurality of protruding portions 202 may be formed at (e.g., in) a surface of the alignment layer 200. The recessed portions 201 and the protruding portions 202 may be alternately arranged. The recessed portions 201 may be portions of the surface of the alignment layer 200 which are recessed in a vertical direction, and the protruding portions 202 may be portions of the surface of the alignment layer 200 where the recessed portions 201 are not formed. The recessed portions 201 and the protruding portions 202 may extend in a first direction D1 and may be arranged in (e.g., arranged along) a second direction D2 perpendicular (e.g., substantially perpendicular) to the first direction D1.

A width L of each recessed portion 201 may be 100 nm or less, and a depth D of each recessed portion 201 may be 70 nm or more. The recessed portions 201 may be arranged at intervals I of 100 nm or less, and the intervals I between the recessed portions 201 may be regular. The width L of each recessed portion 201 refers to a length by which the recessed portion 201 extends in the second direction D2 or the interval I between two neighboring protruding portions 202. The depth D of each recessed portion 201 refers to a height from the bottom of the recessed portion 201 to the top of a protruding portion 202.

When the width L of each recessed portion 201 is 100 nm or less, liquid crystals 301 can be effectively aligned through nanoconfinement, and light incident on the alignment layer 200 may not or substantially not be interfered with. The width L of each recessed portion 201 may be, but is not limited to, 10 nm or more.

When the interval I between the recessed portions 201 is 100 nm or less, liquid crystals 301 located in areas where the recessed portions 201 are not formed can also be effectively aligned, and light incident on the alignment layer 200 may not or substantially not be interfered with. The interval I between the recessed portions 201 may be, but is not limited to, 10 nm or more.

A vertical cross-section of each recessed portion 201 may have a rectangular or square shape. However, the vertical cross-section of each recessed portion 201 is not limited to the rectangular or square shape and may also have a shape such as a triangular shape or a polygonal shape including curves. In addition, the recessed portions 201 may have the same (e.g., substantially the same) vertical cross-sectional shape. The vertical cross-section denotes a cross-section of the alignment layer 200 cut in a third direction D3 perpendicular (e.g., substantially perpendicular) to both the first direction D1 and the second direction D2.

The alignment layer 200 may include a photocured polymer material. For example, the alignment layer 200 may include a material obtained by curing a photocurable polymer material through light irradiation. In addition, an uncured, photocurable polymer material may remain in the alignment layer 200.

In an embodiment, the alignment layer 200 may include a material obtained by curing an ultraviolet (UV)-curable acrylic polymer through UV irradiation and may include a tiny (e.g., negligible) amount of uncured acrylic polymer.

The alignment layer 200 may be manufactured by filling a mold having the protruding portions 202 with a photocurable polymer material and irradiating light such as UV light to cure the photocurable polymer material. The recessed portions 201 of the surface of the alignment layer 200 may be formed by patterning the surface of the alignment layer 200 with the protruding portions 202 of the mold. This is described in more detail herein.

The polarizing material layer 300 is disposed on the alignment layer 200. The polarizing material layer 300 may include the liquid crystals 301 and a dichroic dye 302.

The liquid crystals 301 may be any suitable materials exhibiting liquid crystal properties and the term “liquid crystals,” as used herein, may be a term encompassing all of a liquid crystal monomer, a polymer of liquid crystal monomers, and/or a liquid crystal polymer.

For example, the liquid crystals 301 may include a polymer of reactive mesogens. The polymer of the reactive mesogens may be a material formed by polymerizing reactive mesogens having polymerizable end groups using UV light or heat. In this case, some unpolymerized reactive mesogens may, but do not necessarily, remain in the polarizing material layer 300.

The liquid crystals 301 may be thermotropic liquid crystals having a liquid crystal phase at a specific (e.g., set) temperature condition or a polymer of the thermotropic liquid crystals. Examples of the thermotropic liquid crystals include nematic liquid crystals, smectic liquid crystals, and cholesteric liquid crystals. The liquid crystals 301 may, for example, be, but are not limited to, smectic liquid crystals or a polymer of the smectic liquid crystals, and, for example, may be, but are not limited to, smectic B liquid crystals or a polymer of the smectic B liquid crystals.

The liquid crystals 301 may have, but are not limited to, an anisotropic or chained liquid crystal phase.

In an embodiment, the liquid crystals 301 may be a polymer of thermotropic liquid crystal monomers having reactive end groups.

The dichroic dye 302 may be a dye which absorbs a polarization component parallel (e.g., substantially parallel) to an axial direction and transmits a polarization component perpendicular (e.g., substantially perpendicular) to the axial direction. The dichroic dye 302 may include an azo dye, an anthraquinone dye, and/or an iodine dye, and may preferably include an azo dye. However, the dichroic dye 302 is not limited to the above examples, and other dyes, pigments and pigments having dichroism can also be freely used.

The dichroic dye 302 may include one or more of a dye having a yellow color, a dye having a magenta color, and/or a dye having a cyan color. For example, the dichroic dye 302 may be substantially black by including all of the yellow dye, the magenta dye, and the cyan dye. In some embodiments, the dichroic dye 302 may include one or more of a red dye, a green dye and a blue dye, and may realize black by including all of the red dye, the green dye, and the blue dye.

The liquid crystals 301 and the dichroic dye 302 may be mixed with each other. For example, the dichroic dye 302, which is smaller in amount than the liquid crystals 301, may be dispersed in spaces between molecules of the liquid crystals 301.

The liquid crystals 301 may be aligned in a specific (e.g., set) direction by the recessed portions 201 of the alignment layer 200. Accordingly, the dichroic dye 302 mixed with a polymer of the liquid crystals 301 may also be aligned in the direction in which the polymer of the liquid crystals 301 are aligned and polarize light incident on the polarizing material layer 300. This is described in more detail herein.

A thickness of the polarizing material layer 300 may be, but is not limited to, from several micrometers (μm) to several tens of micrometers.

In an embodiment, the polarizing material layer 300 may further include a crosslinking agent and a solvent. The crosslinking agent may be a material that forms cross-linking so as to improve (e.g., increase) the degree (e.g., amount) of curing of the polarizing material layer 300, and the solvent may be a material in which the liquid crystals 301 and the dichroic dye 302 are dissolved. However, the crosslinking agent and/or the solvent is not necessarily included in the polarizing material layer 300 and can be omitted or replaced with another material if necessary or desired.

The protective layer 400 is disposed on the polarizing material layer 300. The protective layer 400 may be a layer for protecting or sealing the liquid crystals 301 and the dichroic dye 302 contained in the polarizing material layer 300.

The protective layer 400 may include a water-soluble polymer material. In an embodiment, the protective layer 400 may include polyvinyl alcohol (PVA) which is one of the water-soluble polymer materials.

Since the liquid crystals 301 and the dichroic dye 302 that form the polarizing material layer 300 are mostly fat-soluble materials, the protective layer 400 covering the polarizing material layer 300 may be made of a water-soluble polymer material to effectively protect the polarizing material layer 300 from being damaged.

Although not illustrated in the drawings, a functional film such as an additional protective film or a retardation film (protective film) may be disposed on the protective layer 400. In some embodiments, the functional film may be disposed under the base substrate 100 or between layers in the polarizer 10.

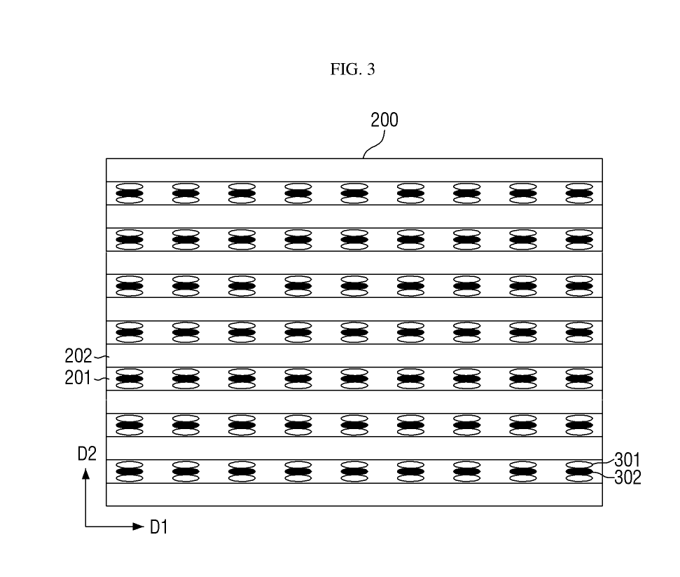

FIG. 3 is a plan view schematically illustrating a state in which polarizing materials are arranged on the alignment layer 200 of the polarizer 10 of FIG. 1.

Referring to FIG. 3, the recessed portions 201 and the protruding portions 202 extending in the first direction D1 are alternately arranged in (e.g., arranged along) the surface of the alignment layer 200 in the second direction D2 (perpendicular (e.g., substantially perpendicular) to the first direction D1), and the liquid crystals 301 and the dichroic dye 302 are arranged on the alignment layer 200.

Molecules of the liquid crystals 301 may be disposed in the recessed portions 201 of the alignment layer 200. The spaces in which the molecules of the liquid crystals 301 can be positioned are limited to the recessed portions 201, each having a small width of about 100 nm or less. Therefore, the molecules of the liquid crystals 301 are aligned in the extending direction of the recessed portions 201 to maintain a low energy state.

Accordingly, the dichroic dye 302 located between the liquid crystals 301 may also be aligned along the alignment direction of the liquid crystals 301. Since the dichroic dye 302 is a material that absorbs a polarization component parallel (e.g., substantially parallel) to an axial direction and transmits a polarization component perpendicular (e.g., substantially perpendicular) to the axial direction, the dichroic dye 302 aligned in a specific (e.g., set) direction polarizes incident light in the specific (e.g., set) direction. The dichroic dye 302 that polarizes incident light is referred to as a guest material, and the liquid crystals 301 that align the dichroic dye 302 in a specific (e.g., set) direction are referred to as a host material.

In some embodiments, the liquid crystals 301 and the dichroic dye 302 may also be disposed on the protruding portions 202 or above the surface of the alignment layer 200. The liquid crystals 301 have a tendency to maintain a low energy state by being aligned in the same (e.g., substantially the same) direction as the molecules of the liquid crystals 301 aligned in the recessed portions 201.

As described above, the polarizer 10 of the present disclosure can polarize incident light in a specific (e.g., set) direction by easily and stably aligning the molecules of the liquid crystals 301 and the dichroic dye 302 using the alignment layer 200 whose surface is patterned to have the recessed portions 201.

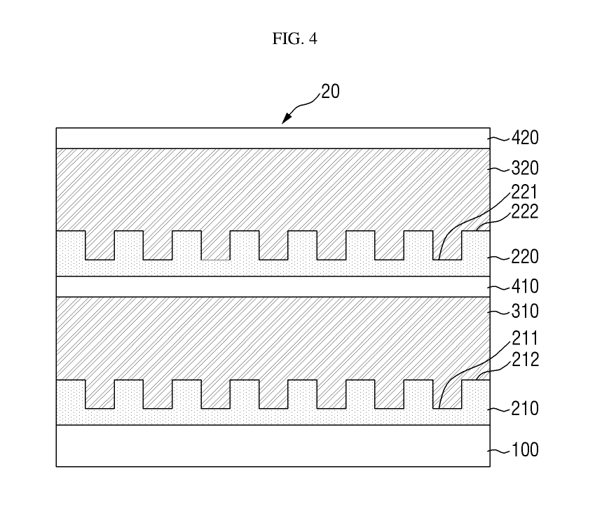

FIG. 4 is a cross-sectional view of a polarizer 20 according to an embodiment.

The polarizer 20 of FIG. 4 is substantially the same as the polarizer 10 of FIG. 1 except that the polarizer 10 of FIG. 1 is stacked in multiple layers. Thus, redundant description thereof is unnecessary and will not be repeated below.

Referring to FIG. 4, a first alignment layer 210, a first polarizing material layer 310 and a first protective layer 410 are sequentially stacked on a base substrate 100, and a second alignment layer 220, a second polarizing material layer 320 and a second protective layer 420 are sequentially stacked on the first protective layer 410.

The first and second alignment layers 210 and 220, the first and second polarizing material layers 310 and 320 and the first and second protective layers 410 and 420 may be substantially the same as the alignment layer 200, the polarizing material layer 300 and the protective layer 400 described above with reference to FIG. 1. For example, each of the first and second alignment layers 210 and 220 may also include a plurality of recessed portions 211 or 221 and a plurality of protruding portions 212 or 222, each of the first and second polarizing material layers 310 and 320 may include liquid crystals and a dichroic dye, and each of the first and second protective layers 410 and 420 may include a water-soluble polymer material.

In particular, the first and second alignment layers 210 and 220 as well as the first and second polarizing material layers 310 and 320 can be fat-soluble materials. Therefore, if the first protective layer 410 disposed between the first polarizing material layer 310 and the second alignment layer 220 is made of a water-soluble polymer material, it can prevent the first polarizing material layer 310 and the second alignment layer 220 from directly contacting each other (or reduce a likelihood or degree of such contact), thereby effectively preventing the first polarizing material layer 310 and the second alignment layer 220 from being damaged in the process of manufacturing the polarizer 20 (or reducing a likelihood or degree of such damage).

The first recessed portions 211 and the first protruding portions 212 formed at (e.g., in) the first alignment layer 210 may be aligned in the same (e.g., substantially the same) pattern as the second recessed portions 221 and the second protruding portions 222 formed at (e.g., in) the second alignment layer 220. For example, the first recessed portions 211 and the first protruding portions 212 may completely overlap the second recessed portions 221 and the second protruding portions 222, respectively. When the first and second recessed portions 211 and 221 and the first and second protruding portions 212 and 222 of the first and second alignment layers 210 and 220 are arranged at the same (e.g., substantially the same) positions, the first polarizing material layer 310 and the second polarizing material layer 320 can polarize light in the same (e.g., substantially the same) direction.

If a polarizer is configured as a single layer, its absorbance or polarization degree for some or all wavelengths may not be suitable or sufficient. However, if a polarizer including the alignment layer 210 or 220 and the polarizing material layer 310 or 320 is stacked in multiple layers, the absorbance and the degree of polarization of the polarizer can be improved (e.g., increased).

The dichroic dye included in the first polarizing material layer 310 and the dichroic dye included in the second polarizing material layer 320 may be the same (e.g., substantially the same) kind of material or may be different dyes having different colors as is described herein.

In FIG. 4, the polarizer including the alignment layers 210 or 220 and the polarizing material layer 310 or 320 is stacked in two layers. However, the polarizer can also be stacked in three or more layers to improve (e.g., increase) absorbance and the degree of polarization to a desired or suitable level.

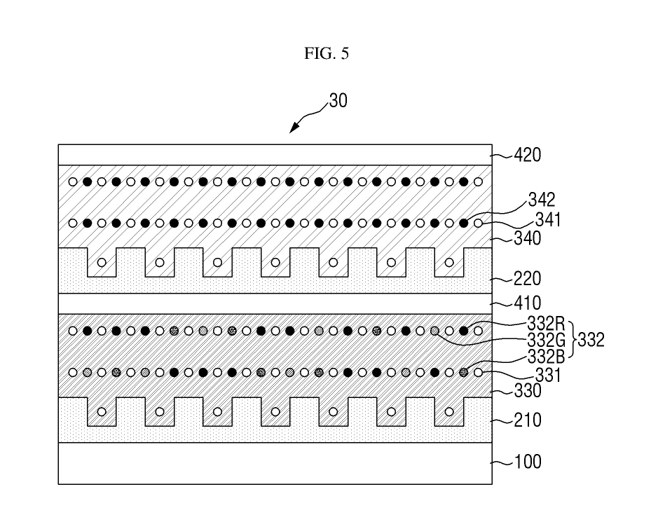

FIG. 5 is a cross-sectional view of a polarizer 30 according to an embodiment.

The polarizer 30 of FIG. 5 is substantially the same as the polarizer 20 of FIG. 4 except that a dichroic dye 332 included in a first polarizing material layer 330 is different from a dichroic dye 342 included in a second polarizing material layer 340. Thus, redundant description thereof is unnecessary and will not be repeated below.

Referring to FIG. 5, the first polarizing material layer 330 includes a first dye 332R, a second dye 332G, a third dye 332B and liquid crystals 331. The second polarizing material layer 340 includes a fourth dye 342 and liquid crystals 341. The first through fourth dyes 332R, 332G, 332B and 342 may all be dichroic dyes.

The first, second and third dyes 332R, 332G and 332B may be different materials (e.g., different from each other), for example, they may be dyes having different colors (e.g., colors different from each other).

For example, the first, second and third dyes 332R, 332G and 332B may be a red dye, a green dye, and a blue dye, respectively. In some embodiments, the first, second and third dyes 332R, 332G and 332B may be a yellow dye, a magenta dye, and a cyan dye, respectively.

The fourth dye 342 may be the same dye as one of the first, second and third dyes 332R, 332G and 332B. Also, the fourth dye 342 may include the same dye as one or more of the first, second and third dyes 332R, 332G and 332B. However, the present disclosure is not limited to the above examples, and the fourth dye 342 may also be a dye different from the first, second and third dyes 332R, 332G and 332B.

The fourth dye 342 may be a dye that absorbs visible light of a long wavelength. For example, the long wavelength may be a wavelength of about 560 to 780 nm that emits red light in a visible light region. However, the long wavelength is not limited to the above range and may also denote a wavelength having a relatively longer range than wavelengths absorbed by the first, second and third dyes 332R, 332G and 332B. For example, the fourth dye 342 may be, but is not limited to, a cyan dye or a blue dye.

In an embodiment, the first, second and third dyes 332R, 332G and 332B may be a yellow dye, a magenta dye, and a cyan dye, respectively. In addition, the fourth dye 342 may be a cyan dye.

Even if a polarizing material layer contains dyes that collectively absorb visible light of a short wavelength, a medium wavelength and a long wavelength at an equal ratio, the absorbance of a long wavelength range may be relatively low. In addition, there is a limit to increasing only a dye, which absorbs a long wavelength, in a single layer due to the problem of solubility. However, if the polarizing material layer 340 that absorbs a relatively long wavelength is additionally placed as illustrated in FIG. 5, the absorbance of the long wavelength range can be compensated (e.g., increased).

In FIG. 5, the first, second and third dyes 332R, 332G and 332B are included in the first polarizing material layer 330, and the fourth dye 342 is included in the second polarizing material layer 340. However, the fourth dye 342 can also be included in the first polarizing material layer 330, and the first, second and third dyes 332R, 332G and 332B can also be included in the second polarizing material layer 340.

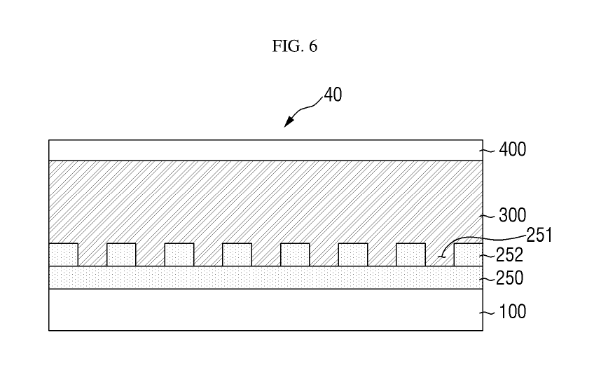

FIG. 6 is a cross-sectional view of a polarizer 40 according to an embodiment.

The polarizer 40 of FIG. 6 is substantially the same as the polarizer 10 of FIG. 1 except that a plurality of protruding portions 252 are disposed on an alignment layer 250. Thus, redundant description thereof is unnecessary and will not be repeated below.

Referring to FIG. 6, the protruding portions 252 are disposed on a surface of the alignment layer 250, and each recessed portion 251 is defined by a space between neighboring protruding portions 252. For example, while the protruding portions 202 and the recessed portions 201 are directly and integrally formed at (e.g., in) the surface of the alignment layer 200 in FIG. 1, the protruding portions 252 are formed on the flat surface of the alignment layer 250 to be separate from the alignment layer 250 in FIG. 6. In this case, the alignment layer 250 may be manufactured by, but the method is not limited to, applying a photoresist material to a flat (e.g., substantially flat) substrate and then patterning the photoresist material to form the protruding portions 252.

A width of each protruding portion 252 and an interval between the protruding portions 252 may be 100 nm or less. This may indicate that the width of each recessed portion 251 and an interval between the recessed portions 251 are 100 nm or less.

When the width of each recessed portion 251 and the interval between the recessed portions 251 are 100 nm or less, a liquid crystal polymer can be effectively aligned through nanoconfinement, light incident on the alignment layer 250 may not be interfered with, and liquid crystals located in areas where the recessed portions 251 are not formed can be effectively aligned as described above. Similarly, the width of each recessed portion 251 and the interval between the recessed portions 251 may be, but is not limited to, 10 nm or more.

The polarizer 40 of FIG. 6 can also be stacked in multiple layers as illustrated in FIG. 4, and each polarizing material layer 300 can include a different dichroic dye as illustrated in FIG. 5.

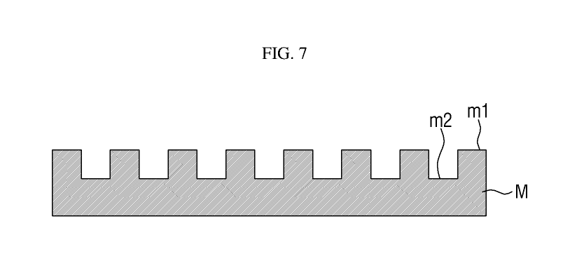

FIGS. 7 through 10 are cross-sectional views for explaining operations of a method of manufacturing the alignment layer 200 of the polarizer 10 illustrated in FIG. 1.

Referring to FIG. 7, a mold M having a plurality of protruding portions m1 and a plurality of recessed portions m2 in its surface is prepared. The protruding portions m1 and the recessed portions m2 may extend in a direction (e.g., a set direction) and may be alternately arranged.

The mold M may be made of a silicon (Si) material. However, the material that forms the mold M is not limited to the silicon material. The mold M may also be made of a material having a low surface energy for a photocurable polymer material P which is described herein, or the surface of the mold M may be coated with the above material.

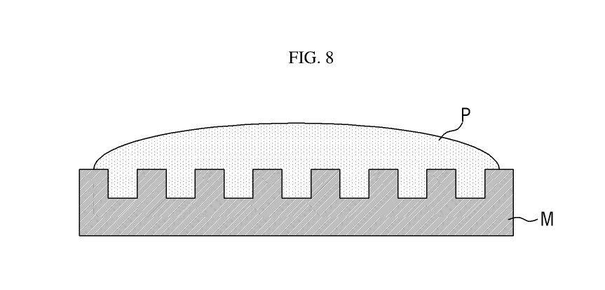

Referring to FIG. 8, the photocurable polymer material P is applied onto the surface of the mold M having the protruding portions m1 and the recessed portions m2. Part of the photocurable polymer material P may fill the recessed portions m2 of the mold M.

The photocurable polymer material P may include, but is not limited to, an acrylic polymer which is cured by UV irradiation.

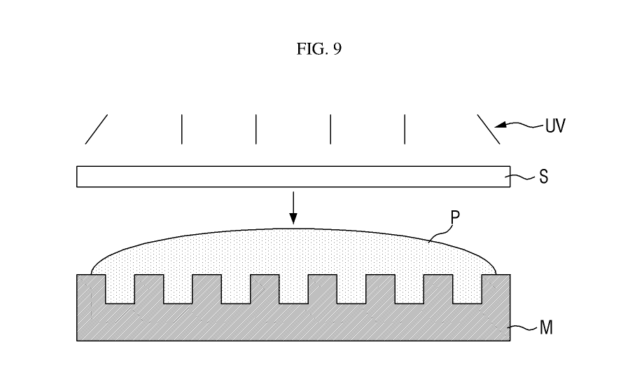

Referring to FIG. 9, a support member S is attached onto the applied photocurable polymer material P, and then UV light is irradiated to cure the photocurable polymer material P.

The support member S may be made of polyethylene terephthalate (PET). However, the material that forms the support member S is not limited to PET, and the support member S may also be made of a material having a relatively high surface energy for the photocurable polymer material P, or a surface of the support member S may be coated with the foregoing material.

In FIG. 9, a material cured by UV light is used as an example of the photocurable polymer material P. However, the photocurable polymer material P is not limited to this material and may also be a material cured by a wavelength other than UV light or a material cured by a condition (for example, such as heat or presence or addition of a solvent) other than light.

When the photocurable polymer material P is a material cured by light irradiation, it can be cured at room temperature without requiring any heat (e.g., without requiring heating). Therefore, liquid crystals and a dye contained in a polarizing material layer can be prevented from being damaged by heat (or a likelihood or degree of such damage can be reduced), which is advantageous when a polarizer is formed to have multiple layers.

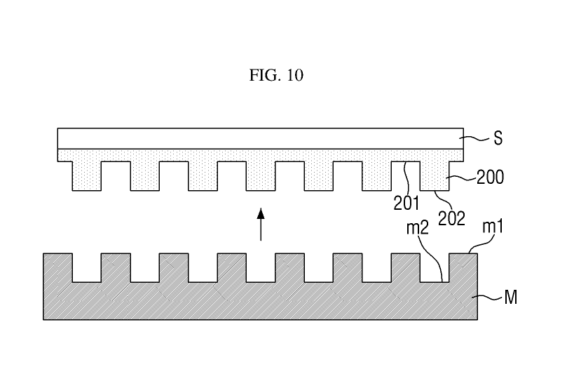

Referring to FIG. 10, the cured polymer material is separated from the mold M. While the mold M has a low surface energy for the photocurable polymer material P, the support member S has a relatively high surface energy for the photocurable polymer material P. Therefore, the cured polymer can be detached from the mold M in a state where it is attached to the support member S.

The cured polymer material may have a plurality of recessed portions 201 formed at positions corresponding to the protruding portions m1 of the mold M and a plurality of protruding portions 202 formed at positions corresponding to the recessed portions m2 of the mold M. Therefore, the cured polymer material can be used as an alignment layer 200 of embodiments of the present disclosure.

Next, a polarizing material layer 300 and a protective layer 400 are formed on the alignment layer 200 to produce the polarizer 10 illustrated in FIG. 1. After the supporting member S is detached from the polarizer 10, the polarizer 10 may be directly attached, for use, to a display panel.

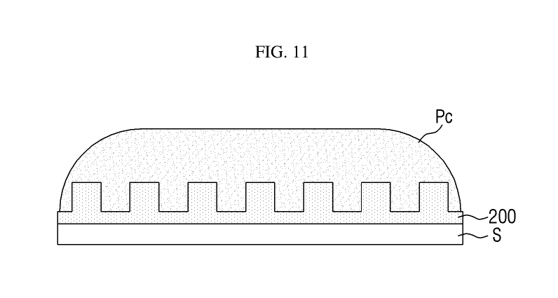

FIGS. 11 through 13 are cross-sectional views for explaining an operation of manufacturing a plurality of alignment layers 200 using the alignment layer 200 manufactured in FIG. 10.

Referring to FIG. 11, a photocurable polymer material Pc is applied onto a surface of the alignment layer 200 manufactured in FIG. 10. The photocurable polymer material Pc may be applied to the surface of the alignment layer 200 where the recessed portions 201 and the protruding portions 202 are formed. Part of the photocurable polymer material Pc may fill the recessed portions 201 of the alignment layer 200.

The photocurable polymer material Pc may be, but is not limited to, a photocurable polymer material that is the same or substantially the same as the photocurable polymer material P used with respect to FIG. 8.

In an embodiment, the surface of the alignment layer 200 may be coated with teflon, and a photocurable polymer may be mixed with the teflon to minimize (or reduce) the adhesion between the surface of the alignment layer 200 and the photocurable polymer material Pc.

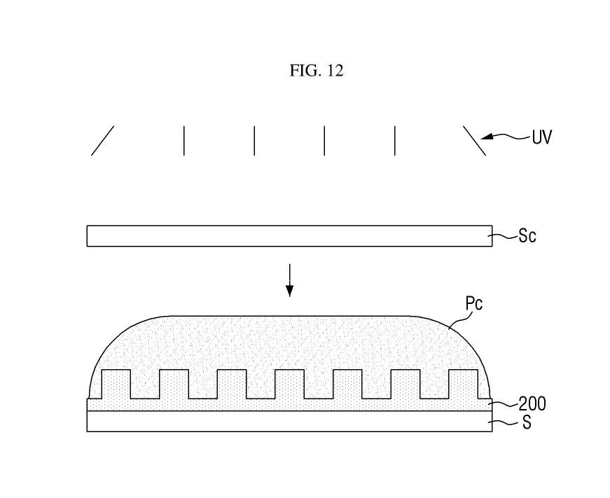

Referring to FIG. 12, a support member Sc is attached onto the applied photocurable polymer material Pc, and UV light is irradiated to cure the photocurable polymer material Pc. The operation of FIG. 12 may be substantially the same as the operation of FIG. 9.

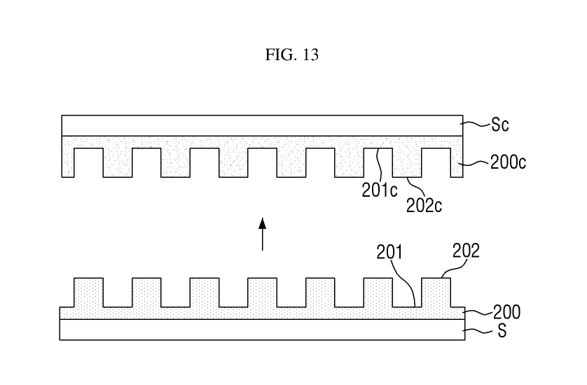

Referring to FIG. 13, the cured polymer material is separated from the alignment layer 200.

The cured polymer material may be a duplicate layer 200c having a plurality of recessed portions 201c formed at positions corresponding to the protruding portions 202 of the alignment layer 200 and a plurality of protruding portions 202c formed at positions corresponding to the recessed portions 201 of the alignment layer 200. The duplicate layer 200c may have substantially the same surface pattern as the alignment layer 200 if the protruding portions 202 and the recessed portions 201 of the alignment layer 200 have the same (e.g., substantially the same) shape and size.

A plurality of alignment layers 200 can be manufactured by repeating the operations of FIGS. 11 through 13 using the alignment layer 200 or the duplicate layer 200c, and a layer duplicated from the duplicate layer 200c may have the same (e.g., substantially the same) recessed and protruding portions as those of the initial alignment layer 200.

According to embodiments, a plurality of recessed portions are formed at (e.g., in) a surface of an alignment layer of a polarizer to stably align liquid crystals through the nanoconfinement effect. Therefore, the polarizer can exhibit superior polarization degree and absorbance.

However, the effects of embodiments of the present disclosure are not restricted to the ones described herein. The above and other effects of embodiments of the present disclosure will become more apparent to one of ordinary skill in the art to which the present disclosure pertains by referencing the claims.

While the subject matter of the present disclosure has been particularly illustrated and described with reference to embodiments thereof, it will be understood by those of ordinary skill in the art that various changes in form and detail may be made therein without departing from the spirit and scope of the present invention as defined by the following claims, and equivalents thereof. The disclosed embodiments should be considered in a descriptive sense only and not for purposes of limitation.

What is claimed is:

1. A polarizer comprising:
an alignment layer comprising a photocured polymer material and having a plurality of recessed portions formed at a surface of the alignment layer to extend in a first direction; and
a polarizing material layer disposed on the surface of the alignment layer having the recessed portions, the polarizing material layer comprising thermotropic liquid crystals and a dichroic dye.

2. The polarizer of claim 1, wherein the liquid crystals comprise a polymer of reactive mesogens.

3. The polarizer of claim 1, wherein each of the recessed portions has a width of 100 nm or less.

4. The polarizer of claim 1, wherein each of the recessed portions has a depth of 70 nm or more.

5. The polarizer of claim 1, wherein the recessed portions are arranged along a second direction perpendicular to the first direction and are arranged at regular intervals.

6. The polarizer of claim 5, wherein the interval between the recessed portions is 100 nm or less.

7. The polarizer of claim 1, wherein vertical cross-sections of the recessed portions have the same shape.

8. The polarizer of claim 1, wherein the photocured polymer material comprises an acrylic polymer cured by ultraviolet (UV) irradiation.

9. A polarizer comprising:
a first alignment layer having a plurality of recessed portions formed at a surface of the alignment layer to extend in a direction;
a first polarizing material layer disposed on the surface of the first alignment layer having the recessed portions, the first polarizing material layer comprising liquid crystals and a dichroic dye;
an intermediate layer disposed on the first polarizing material layer;
a second alignment layer disposed on the intermediate layer and having a plurality of recessed portions formed at a surface to extend in the direction; and
a second polarizing material layer disposed on the surface of the second alignment layer having the recessed portions, the second polarizing material layer comprising liquid crystals and a dichroic dye.

10. The polarizer of claim 9, wherein the liquid crystals comprise thermotropic liquid crystals.

11. The polarizer of claim 9, wherein the intermediate layer comprises a water-soluble polymer material.

12. The polarizer of claim 9, wherein the dye contained in the first polarizing material layer and the dye contained in the second polarizing material layer are the same material or different materials.

13. The polarizer of claim 12, wherein the dye contained in the first polarizing material layer comprises a yellow dye, a magenta dye, and a cyan dye.

14. The polarizer of claim 13, wherein the dye contained in the second polarizing material layer is the same as one or more of the dyes contained in the first polarizing material layer.

15. The polarizer of claim 13, wherein the dye contained in the second polarizing material layer is different from the dye contained in the first polarizing material layer.

16. The polarizer of claim 12, wherein the dye contained in the first polarizing material layer comprises a red dye, a green dye, and a blue dye.

17. A polarizer comprising:
an alignment layer having a plurality of protruding portions formed at a surface to extend in a direction; and
a polarizing material layer disposed on the surface of the alignment layer having the protruding portions, the polarizing material layer comprising thermotropic liquid crystals and a dichroic dye.

18. The polarizer of claim 17, wherein the liquid crystals comprise a polymer of reactive mesogens.

19. The polarizer of claim 17, wherein an interval between the protruding portions is 100 nm or less.

20. The polarizer of claim 17, wherein each of the protruding portions has a width of 100 nm or less.
